(19) United States
(12) Patent Application Publication
(10) Pub. No.: US 2026/0131570 A1
(43) Pub. Date: May 14, 2026

(54) LIQUID DISCHARGE HEAD, HEAD UNIT, AND LIQUID DISCHARGE APPARATUS

(71) Applicants: Yuki FUJIMURA, Kanagawa (JP); Keishi MIWA, Kanagawa (JP)

(72) Inventors: Yuki FUJIMURA, Kanagawa (JP); Keishi MIWA, Kanagawa (JP)

(21) Appl. No.: 19/366,667

(22) Filed: Oct. 23, 2025

(30) Foreign Application Priority Data
Nov. 14, 2024 (JP) 2024-199005

(51) Int. Cl. B41J 2/14; B41J 2/175; B41J 2/19

(52) U.S. Cl. CPC B41J 2/14201; B41J 2/175; B41J 2/19; B41J 2002/14306; B41J 2002/14459; B41J 2202/07

(57) ABSTRACT

A liquid discharge head includes a plurality of nozzles to discharge liquid, a plurality of pressure chambers communicating with the nozzles, a plurality of individual channels communicating with the plurality of pressure chambers, a plurality of common channel branches disposed to overlap the plurality of pressure chambers when viewed in a discharging direction of the liquid discharged from the plurality of nozzles, and a common channel mainstream communicating with the plurality of common channel branches. The plurality of common channel branches communicate with the plurality of individual channels. Each of the plurality of common channel branches is inclined at an angle in a range greater than 45° and smaller than 90° with respect to the common channel mainstream. A protrusion having a same height as a height of a side wall surface of a groove forming one of the plurality of common channel branches protrudes from the side wall surface.

### CROSS-REFERENCE TO RELATED APPLICATION

This patent application is based on and claims priority pursuant to 35 U.S.C. § 119(a) to Japanese Patent Application No. 2024-199005, filed on Nov. 14, 2024, in the Japan Patent Office, the entire disclosure of which is hereby incorporated by reference herein.

### BACKGROUND

### Technical Field

The present disclosure relates to a liquid discharge head, a head unit, and a liquid discharge apparatus.

### Related Art

As a liquid discharge head mounted on an inkjet type image forming apparatus, for example, a liquid discharge head has been proposed that includes nozzles to discharge liquid, pressure chambers communicating with the nozzles, and individual channels communicating with the pressure chambers.

For example, a liquid discharge head includes one or a plurality of common channel mainstreams and a plurality of common channel branches branching from the common channel mainstream(s), as a common channel(s) communicating with a plurality of individual channels.

In the liquid discharge head described above, the plurality of common channel branches extend obliquely with respect to the common channel mainstream(s). In the configuration in which the plurality of common channel branches extend obliquely with respect to the common channel mainstream(s), as described above, there is a possibility that deformation such as twisting occurs in the liquid discharge head due to oblique extension of the common channel branches. In such a liquid discharge head, however, measures against such deformation have not sufficiently been studied.

### SUMMARY

The present disclosure described herein provides a liquid discharge head that includes a plurality of nozzles, a plurality of pressure chambers, a plurality of individual channels, a plurality of common channel branches, and a common channel mainstream. The plurality of nozzles discharge liquid. The plurality of pressure chambers communicate with the plurality of nozzles. The plurality of individual channels communicate with the plurality of pressure chambers. The plurality of common channel branches are disposed to overlap the plurality of pressure chambers when viewed in a discharging direction of the liquid discharged from the plurality of nozzles. The plurality of common channel branches communicate with the plurality of individual channels. The common channel mainstream communicate with the plurality of common channel branches. Each of the plurality of common channel branches is inclined at an angle in a range greater than 45° and smaller than 90° with respect to the common channel mainstream. A protrusion having a same height as a height of a side wall surface of a groove forming one of the plurality of common channel branches protrudes from the side wall surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a common channel member of a liquid discharge head according to an embodiment of the present disclosure;

FIG. 2 is a cross-sectional view of the common channel member cut along a line A-A illustrated in FIG. 1;

FIG. 3 is a cross-sectional view of a protrusion that protrudes in a direction orthogonal to a branch;

FIG. 4 is a cross-sectional view of a protrusion that protrudes obliquely with respect to a branch;

FIG. 5 is a cross-sectional view of a protrusion that protrudes obliquely with respect to a branch;

FIG. 6 is a cross-sectional view protrusions that are disposed to be shifted from each other;

FIG. 7 is a cross-sectional view of a protrusion according to a modification;

FIG. 8 is a cross-sectional view of a protrusion according to a modification;

FIG. 9 is a cross-sectional view of a protrusion according to a modification;

FIG. 10 is a table illustrating results and contents of effect confirmation tests;

FIG. 11 is an exploded perspective view of a head unit, illustrating an overall configuration of the head unit;

FIG. 12 is a cross-sectional view of the head unit illustrated in FIG. 11;

FIG. 13 is a schematic view of an overall configuration of an inkjet type image forming apparatus that is an example of a liquid discharge apparatus;

FIG. 14 is a plan view of a line type head unit;

FIG. 15 is a plan view of a serial type head unit;

FIG. 16 is a schematic view of an electrode manufacturing apparatus, illustrating an overall configuration of the electrode manufacturing apparatus;

FIG. 17 is an exploded perspective view of a liquid discharge head according to a comparative example, illustrating an overall configuration of the liquid discharge head;

FIG. 18 is an enlarged, exploded perspective view of a part of the liquid discharge head according to the comparative example;

FIG. 19 is a plan view of an individual channel member and a common channel member of the liquid discharge head according to the comparative example viewed in a stacking direction of the individual channel member and the common channel member or a discharging direction of liquid discharged from nozzles;

FIG. 20 is a diagram illustrating deformation of the liquid discharge head according to the comparative example; and

FIG. 21 is a plan view of pressure chambers disposed between branches.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Before describing a liquid discharge head according to the present disclosure, a configuration of a liquid discharge head according to a comparative example different from embodiments of the present disclosure and its disadvantage will first be described herein. Constituent elements, such as members or constituent components having the same or like functions or shapes, are denoted with the same or like reference signs in the drawings for use in below description and duplicate descriptions thereof will be omitted.

FIG. 17 is an exploded perspective view of a liquid discharge head 200 according to a comparative example, illustrating an overall configuration of the liquid discharge head 200.

As illustrated in FIG. 17, the liquid discharge head 200 according to the comparative example includes, for example, a nozzle plate 201, an individual channel member 202, a vibration plate member 203, a common channel member 204, a damper member 205, a damper frame member 206, a frame member 207, and a wiring substrate 209 on which a drive circuit 208 is implemented.

The nozzle plate 201, the individual channel member 202, the vibration plate member 203, the common channel member 204, the damper member 205, the damper frame member 206, and the frame member 207 are stacked with and joined to each other in this order. The frame member 207 is provided with a supply port 210 for supplying liquid from an external liquid circulation path and a collection port 211 for allowing the liquid to return to the external liquid circulation path.

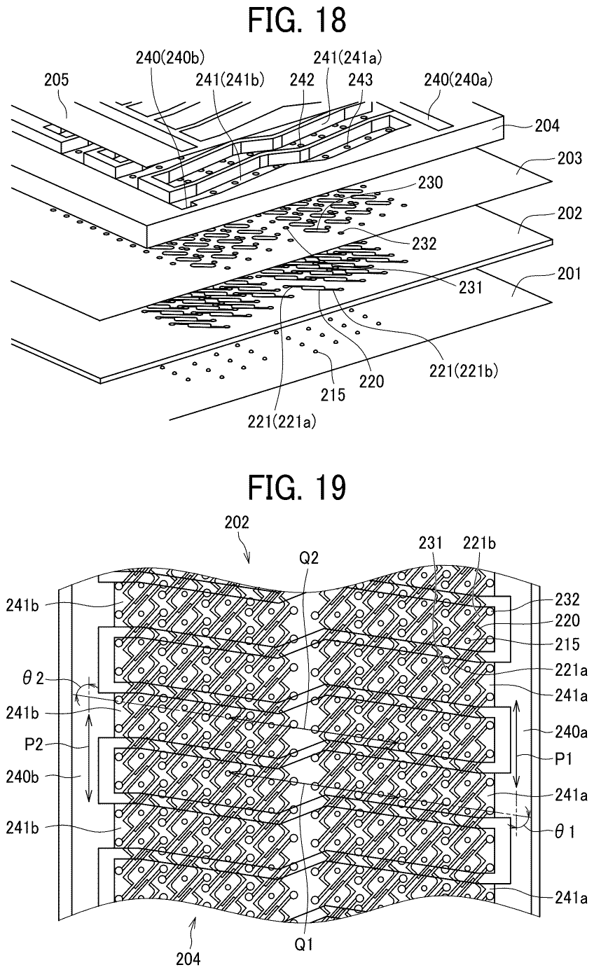

FIG. 18 is an enlarged, exploded perspective view of a part of the liquid discharge head 200 according to the comparative example.

As illustrated in FIG. 18, the nozzle plate 201 is provided with a plurality of nozzles 215 that discharge the liquid. The plurality of nozzles 215 are two-dimensionally disposed in a matrix to form nozzle groups.

The individual channel member 202 is a member having a plurality of pressure chambers (individual liquid chambers) 220 respectively communicating with the plurality of nozzles 215 and a plurality of individual channels 221 respectively communicating with the pressure chambers 220. The plurality of pressure chambers 220 are provided to respectively correspond to the nozzles 215 in a one-by-one manner. When the individual channel member 202 is joined to the nozzle plate 201, the pressure chambers 220 are disposed to respectively correspond to and communicate with the nozzles 215. The individual channels 221 each include an individual supply channel 221a and an individual collection channel 221b that are respectively disposed on sides opposite to each other with the pressure chamber 220 interposed. Both the individual supply channel 221a and the individual collection channel 221b communicate with the pressure chamber 220.

The vibration plate member 203 is a deformable member joined to a side of the individual channel member 202, which is opposite to a side of the individual channel member 202, which faces the nozzle plate 201. As the vibration plate member 203 is joined to the individual channel member 202, the vibration plate member 203 seals openings of grooves forming the pressure chambers 220 of the individual channel member 202, and the vibration plate member 203 forms deformable wall surfaces at the sealed positions. Piezoelectric elements 230 are disposed at positions on the vibration plate member 203, which respectively correspond to the pressure chambers 220. The piezoelectric element 230 is, for example, a member in which a piezoelectric layer and internal electrodes are alternately stacked with each other. The internal electrodes of the piezoelectric element 230 are coupled to the wiring substrate 209 (see FIG. 17) via external electrodes. When a drive voltage is applied to the piezoelectric element 230 via the wiring substrate 209, the piezoelectric element 230 expands and contracts, and the vibration plate member 203 deforms. The vibration plate member 203 is provided with supply-side opening portions 231 each communicating with the individual supply channel 221a and collection-side opening portions 232 each communicating with the individual collection channel 221b.

The common channel member 204 is a member having a plurality of common channel mainstreams 240 and a plurality of common channel branches 241 respectively branching from the common channel mainstreams 240. The common channel mainstreams 240 include a common supply channel mainstream 240a communicating with the supply port 210 (see FIG. 17) and a common collection channel mainstream 240b communicating with the collection port 211 (see FIG. 17). The common channel branches 241 include a plurality of common supply channel branches 241a branching from the common supply channel mainstream 240a and a plurality of common collection channel branches 241b branching from the common collection channel mainstream 240b. The common supply channel branches 241a are each provided with a plurality of supply ports 242 respectively communicating with the supply-side opening portions 231 of the vibration plate member 203. On the other hand, each of the common collection channel branches 241b is provided with a plurality of collection ports 243 respectively communicating with the collection-side opening portions 232 of the vibration plate member 203. When the common channel member 204 and the vibration plate member 203 are joined to each other, and the vibration plate member 203 and the individual channel member 202 are further joined to each other, the common supply channel branches 241a respectively communicate with the individual supply channels 221a via the supply-side opening portions 231 of the vibration plate member 203, and the common collection channel branches 241b respectively communicate with the individual collection channels 221b via the collection-side opening portions 232 of the vibration plate member 203.

The damper member 205 is a deformable member joined to a side of the common channel member 204, which is opposite to a side of the common channel member 204, which faces the vibration plate member 203. As the damper member 205 is joined to the common channel member 204, openings of grooves forming the common supply channel mainstream 240a, the common collection channel mainstream 240b, the common supply channel branches 241a, and the common collection channel branches 241b are respectively sealed.

When the liquid is supplied from the external liquid circulation path via the supply port 210, in the comparative example having the configuration described above, the supplied liquid is supplied to the pressure chambers 220 via the common supply channel mainstream 240a, the common supply channel branches 241a, the supply ports 242, the supply-side opening portions 231, and the individual supply channels 221a.

The liquid supplied to the pressure chambers 220 is pushed out from the pressure chambers 220 and discharged from each of the nozzles 215 as the piezoelectric elements 230 expand and contract and the vibration plate member 203 deforms. Although, at this time, pressure fluctuation may occur in one of liquid channels (for example, one of the individual supply channels 221a) due to discharging of the liquid, the damper member 205 disposed in the liquid discharge head 200 according to the comparative example makes it possible to suppress propagation of the pressure fluctuation to other ones of the nozzles 215. It is possible to reduce an influence (crosstalk) of the propagation of the pressure fluctuation to the other ones of the nozzles 215, making it possible to stabilize accuracy in discharging of the liquid.

The liquid that has not been discharged from some of the nozzles 215 is returned from the pressure chambers 220 to the external liquid circulation path via the individual collection channels 221b, the collection-side opening portions 232, the collection ports 243, the common collection channel branches 241b, the common collection channel mainstream 240b, and the collection port 211.

Subsequently, a disadvantage in the comparative example is described below.

FIG. 19 is a plan view of the individual channel member 202 and the common channel member 204 of the liquid discharge head 200 according to the comparative example when viewed in a stacking direction of the members or a discharging direction of the liquid discharged from the nozzles 215.

In the comparative example, as illustrated in FIG. 19, the common supply channel mainstream 240a and the common collection channel mainstream 240b are disposed to extend in parallel with each other in upper and lower directions (directions P1 and P2 that arrows indicate) in the drawing. On the other hand, the plurality of common supply channel branches 241a are disposed to extend from the common supply channel mainstream 240a toward a left side (toward the common collection channel mainstream 240b) of FIG. 19, and the plurality of common collection channel branches 241b are disposed to each extend, between each two of the plurality of common supply channel branches 241a, from the common collection channel mainstream 240b toward a right side (toward the common supply channel mainstream 240a) of FIG. 19. That is, the common supply channel branches 241a and the common collection channel branches 241b are alternately disposed between the common supply channel mainstream 240a and the common collection channel mainstream 240b in extension directions (the directions P1 and P2 that the arrows indicate) of the mainstreams.

As illustrated in FIG. 19, the common supply channel branches 241a are disposed to overlap the individual supply channels 221a to communicate with the plurality of individual supply channels 221a to supply the liquid to the plurality of pressure chambers 220. On the other hand, the common collection channel branches 241b are disposed to overlap the individual collection channels 221b to communicate with the plurality of individual collection channels 221b to collect the liquid from the plurality of pressure chambers 220. The pressure chambers 220 are disposed to overlap the common supply channel branches 241a and the common collection channel branches 241b without overlapping the common supply channel mainstream 240a and the common collection channel mainstream 240b.

The common supply channel branches 241a and the common collection channel branches 241b according to the comparative example are disposed to be inclined (to intersect) with respect to the common supply channel mainstream 240a and the common collection channel mainstream 240b. In this case, directions Q1 and Q2 that arrows indicate in FIG. 19, which are extension directions of the common supply channel branches 241a and the common collection channel branches 241b, are respectively inclined at angles θ1 and θ2, each of which is in a range greater than 45° and smaller than 90°, with respect to the directions P1 and P2 that the arrows indicate in the same drawing, which are the extension directions of the common supply channel mainstream 240a and the common collection channel mainstream 240b (45°<θ1 and θ2<90°).

The “extension directions” as used herein mean directions in which a channel mainly extends. When the common supply channel branches 241a and the common collection channel branches 241b all extend each in a bent manner at a middle position, as in the example illustrated in FIG. 19, the directions Q1 and Q2, in which the common supply channel branches 241a and the common collection channel branches 241b extend long, are defined as main “extension directions”.

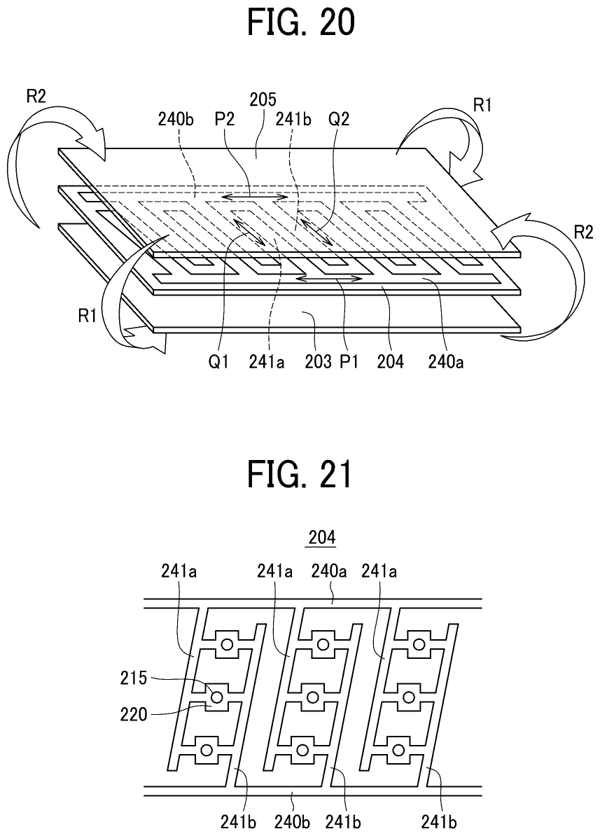

Since the common supply channel branches 241a and the common collection channel branches 241b are all inclined with respect to the common supply channel mainstream 240a and the common collection channel mainstream 240b respectively in the comparative example, as described above, bending stress in directions R1 and R2 that arrows indicate in FIG. 20 acts on the common channel member 204 due to the fact that the branches 241a and 241b are inclined, leading to deformation (strain). In a configuration in which a member (the common channel member 204) including the common supply channel branches 241a and the common collection channel mainstream 240b and a member (the individual channel member 202) including the pressure chambers 220 are separate members and the branches 241a and 241b and the pressure chambers 220 are disposed to overlap each other, as illustrated in the comparative example, in particular, such deformation as illustrated in FIG. 20 easily occurs. That is, with such a configuration as illustrated in the comparative example, in which, although it is possible to bring the branches 241a and 241b close to each other to make compact the common channel member 204, partition walls that partition the branches 241a and 241b from each other are thinned, compared with a configuration (see Japanese Patent No. 5495385) in which the pressure chambers 220 are disposed between the branches 241a and 241b, as illustrated in FIG. 21, for example, it is difficult to acquire rigidity, and there is a tendency that deformation easily occurs.

When members including the common channel member 204 are joined to each other when deformation has occurred in the common channel member 204, in the comparative example, the deformation may possibly result in deterioration of discharging performance of a liquid discharge head. When twisting as illustrated in FIG. 20 has occurred, for example, there is a possibility that a discharging speed of the liquid lowers at a portion where bending stress acts in the direction R1 that the arrow indicates.

An object of the present disclosure is to suppress deformation of a liquid discharge head and to acquire satisfactory discharging performance. Features of the present disclosure will now be described herein with reference to an embodiment of the present disclosure

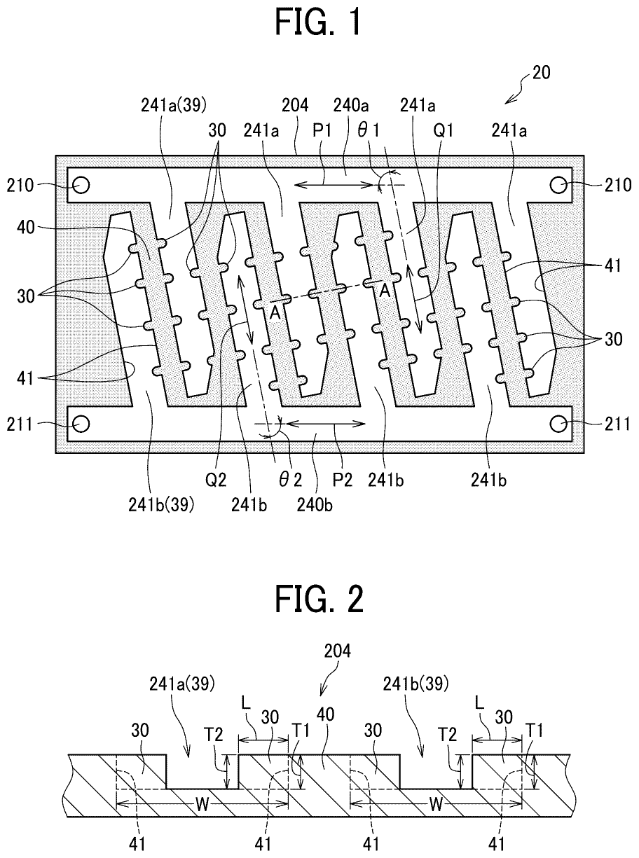

FIG. 1 is a plan view of a common channel member 204 included in a liquid discharge head 20 according to an embodiment of the present disclosure.

In the common channel member 204 of the liquid discharge head 20, as illustrated in FIG. 1, similar to the comparative example described above, common supply channel branches 241a are disposed to be inclined with respect to a common supply channel mainstream 240a and, common collection channel branches 241b are disposed to be inclined with respect to a common collection channel mainstream 240b. That is, extension directions Q1 and Q2, in which the common supply channel branches 241a and the common collection channel branches 241b extend, are respectively inclined at angles θ1 and θ2 (45°<θ1 and θ2<90°), each of which is in a range greater than 45° and smaller than 90°, with respect to extension directions P1 and P2 in which the common supply channel mainstream 240a and the common collection channel mainstream 240b extend.

Although, in FIG. 1, the common supply channel mainstream 240a, the common collection channel mainstream 240b, the common supply channel branches 241a, and the common collection channel branches 241b are illustrated in a simplified manner, compared with the comparative example, the liquid discharge head 20 according to the present embodiment basically has a configuration identical to the configuration of the liquid discharge head 200 according to the comparative example, except for features described below.

In the liquid discharge head 20 according to the present embodiment, as illustrated in FIG. 1, different from the liquid discharge head 200 according to the comparative example, a plurality of protrusions 30 are disposed on side wall surfaces 41 of grooves 39 respectively forming the common supply channel branches 241a and the common collection channel branches 241b. The protrusions 30 are disposed to protrude from both or one of each pair of the side wall surfaces 41, which face each other, of the grooves 39 respectively forming the common supply channel branches 241a and the common collection channel branches 241b. In this case, among the common supply channel branches 241a and the common collection channel branches 241b alternately disposed, some of the protrusions 30 protrude from both of each pair of the side wall surfaces 41 of some of the branches 241a and 241b, other than an outermost one of the common supply channel branches 241a and an outermost one of the common collection channel branches 241b, and other some of the protrusions 30 protrude from only one of a pair of the side wall surfaces 41 of the outermost one of the common supply channel branches 241a and the outermost one of the common collection channel branches 241b. In other words, the protrusions 30 are disposed to protrude from each (both) of the side wall surfaces 41 on sides opposite to each other of each of partition walls 40 that partition the branches 241a and 241b from each other.

FIG. 2 is a cross-sectional view of the common channel member 204 when cut along a line A-A illustrated in FIG. 1.

As illustrated in FIG. 2, each of the protrusions 30 is disposed to have a height T2 identical to a height T1 (a depth of each of the grooves 39) of each of the side wall surfaces 41 of the grooves 39 forming the common supply channel branches 241a and the common collection channel branches 241b. A protrusion amount L (a length of each of the protrusions 30) at which each of the protrusions 30 protrudes from each of the side wall surfaces 41 is set to a protrusion amount to an extent that an appropriate flow of the liquid is not hindered. Specifically, it is preferable that the percentage occupied by the protrusion amount L of one of the protrusions 30 in a width W of each of the grooves 39 be equal to or smaller than 30%.

Since the plurality of protrusions 30 are disposed to protrude from the side wall surfaces 41 forming the common supply channel branches 241a and the common collection channel branches 241b each at the height T2 identical to the height T1 of each of the side wall surfaces 41, in the liquid discharge head 20 according to the present embodiment, as described above, it is possible to suppress deformation of the common channel member 204. That is, since the plurality of protrusions 30 function as reinforcement parts that reinforce the common channel member 204, it is possible to suppress, even in the configuration in which the common supply channel branches 241a and the common collection channel branches 241b are disposed to be inclined with respect to the common supply channel mainstream 240a and the common collection channel mainstream 240b, deformation such as twisting due to the fact that the branches 241a and 241b are inclined. With the liquid discharge head 20 according to the present embodiment, it is possible to avoid, for example, a lowered discharging speed along with deformation, making it possible to ensure satisfactory discharging performance.

In particular, in a configuration in which the branches 241a and 241b and the pressure chambers 220 are disposed in separate members (the common channel member 204 and the individual channel member 202) and the branches 241a and 241b and the pressure chambers 220 are disposed to overlap each other (see FIGS. 17 to 19), similar to the present embodiment, in which it is possible to make the common channel member 204 compact, while the partition walls 40 between the branches 241a and 241b tend to be thin, applying the configuration of the present embodiment makes it possible to reinforce the partition walls 40 to secure rigidity. It is possible to avoid deterioration of discharging performance along with deformation, making it possible to acquire satisfactory discharging performance.

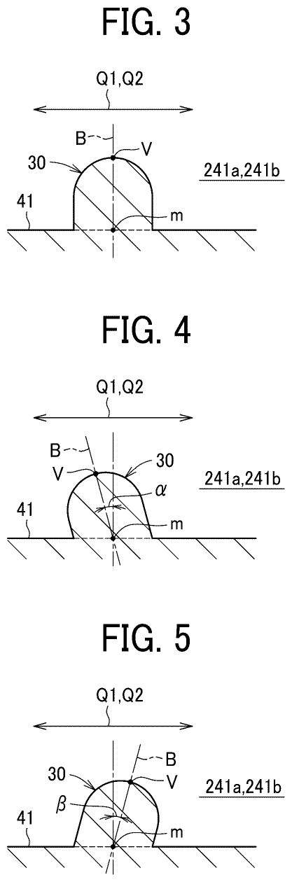

To effectively suppress deformation of the liquid discharge head, it is preferable that protrusion directions of the protrusions 30 be directions orthogonal to the extension directions Q1 and Q2 of the branches 241a and 241b. The “protrusion direction” of each of the protrusions 30 means, as illustrated in FIG. 3, a direction of a straight line B connecting a middle point m on a bottom side (base portion) of the protrusion 30 and a tip v of the protrusion 30, which is farthest from the middle point m, in a state (state when viewed in a plan view) when the protrusion 30 is viewed in the stacking direction of the members or the discharging direction of the liquid. In the present embodiment, it has been configured that the protrusion direction of the protrusion 30 (the direction of the straight line B) is orthogonal to the extension directions Q1 and Q2 of the branches 241a and 241b.

The protrusion direction of the protrusion 30 (the direction of the straight line B) is not necessarily orthogonal to the extension directions Q1 and Q2 of the branches 241a and 241b. For example, as illustrated in FIG. 4 or 5, there may be a case where the protrusion direction of the protrusion 30 (the direction of the straight line B) is an oblique direction with respect to the extension directions Q1 and Q2 of the branches 241a and 241b. In that case, it is preferable that the protrusion direction of the protrusion 30 (the direction of the straight line B) be inclined within a range equal to or smaller than 30° (0°<α and β≤30°) from a direction orthogonal to the extension directions Q1 and Q2 of the branches 241a and 241b, and it is more preferable that the direction be inclined within a range equal to or smaller than 10° (0°<α and β≤10°).

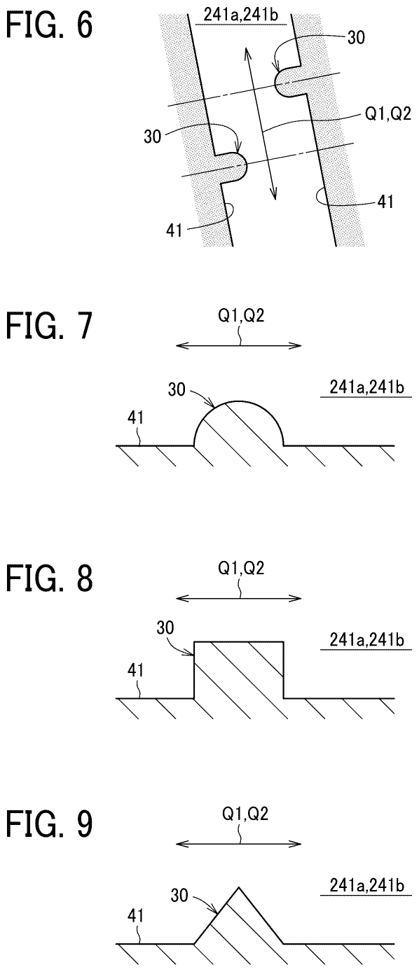

Although, in the example illustrated in FIG. 1, the protrusions 30 are disposed at equal intervals in the extension directions Q1 and Q2 of the common supply channel branches 241a and the common collection channel branches 241b, and are disposed side by side each on a straight line (on the A-A line illustrated in FIG. 1) orthogonal to the extension directions Q1 and Q2 of the branches 241a and 241b, the protrusions 30 are not limited in arrangement to the example illustrated in FIG. 1. For example, similar to an example illustrated in FIG. 6, the protrusions 30 protruding from the side wall surfaces 41 facing each other may be disposed to be shifted from each other in the extension directions Q1 and Q2 of the branches 241a and 241b. When the protrusions 30 are disposed to be shifted from each other in the extension directions Q1 and Q2 of the branches 241a and 241b, as described above, it is possible to secure a wide width between the branches 241a and 241b. It is possible to appropriately change the protrusions 30 in position as long as the supply ports 242 (see FIG. 18) disposed in the common supply channel branches 241a and the collection ports 243 (see FIG. 18) disposed in the common collection channel branches 241b are not blocked.

The protrusions 30 may be each formed in a semicircular shape (only a semicircle), as illustrated in FIG. 7, instead of a case where each of the protrusions protrudes linearly from each of the side wall surfaces 41 and its tip side is formed in a semicircular shape, as illustrated in FIG. 3. When the tip of each of the protrusions 30 is formed in a convex curved surface such as a semicircular shape as illustrated in FIG. 3 or 7, it is possible to suppress accumulation of bubbles or an increase in pressure loss in each of the branches 241a and 241b, making it possible to achieve a smooth flow of the liquid. It is not limited to the case where the tip is formed in the convex curved surface, the protrusions 30 may each have, for example, a quadrangular shape as illustrated in FIG. 8, a triangular shape as illustrated in FIG. 9, or another polygonal shape.

The protrusions 30 may include an identical or different material to or from a material forming the branches 241a and 241b (for example, silicon (Si)). When the protrusions 30 include the identical material to the material of the branches 241a and 241b, it is possible to form the protrusions 30 together with the branches 241a and 241b, making it possible to simplify a manufacturing process.

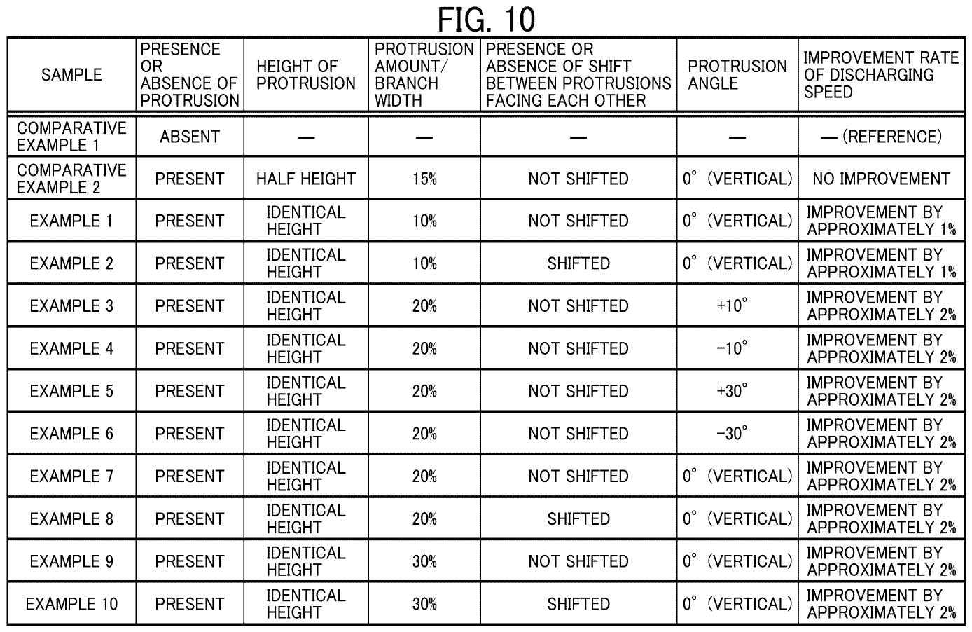

Next, effect confirmation tests for confirming effects of embodiments of the present disclosure will now be described herein with reference to a table illustrated in FIG. 10.

In the effect confirmation tests, a plurality of samples (liquid discharge heads) were prepared, and a discharging speed of each of the samples was evaluated. Specifically, a sample that does not have the protrusions 30 according to embodiments of the present disclosure was prepared as “Comparative Example 1”, the discharging speed in “Comparative Example 1” was used as a reference value, and improvements in discharging speed in others of the samples were evaluated.

As samples other than “Comparative Example 1”, “Comparative Example 2” and Example 1” to “Example 10” of the present disclosure were prepared. In “Comparative Example 2,” the height T2 of each of the protrusions 30 was only half of the height T1 of each of the side wall surfaces 41. In “Example 1” to “Example 10” of the present disclosure, the protrusions 30 each having the height T2 identical to the height T1 of each of the side wall surfaces 41 were provided.

In the table illustrated in FIG. 10, “Protrusion amount/branch width” indicates a percentage occupied by the protrusion amount L of one of the protrusions 30 in the width W (see FIG. 2) of each of the grooves 39 forming the branches 241a and 241b. That is, the greater the protrusion amount L of each of the protrusions 30, the greater the value of “Protrusion amount/branch width”. In FIG. 10, “Presence or absence of shift between protrusions facing each other” indicates whether or not the protrusions 30 protruding from the side wall surfaces 41 facing each other are disposed to be shifted from each other in the extension directions Q1 and Q2 of the branches 241a and 241b. That is, when, as illustrated in FIG. 1, the protrusions 30 are disposed on the straight line (on the A-A line illustrated in FIG. 1) orthogonal to the extension directions Q1 and Q2 of the branches 241a and 241b, “Not shifted” is determined, and, when, as illustrated in FIG. 6, the protrusions 30 are disposed to be shifted from each other in the extension directions Q1 and Q2 of the branches 241a and 241b, “Shifted” is determined. In FIG. 10, “Protrusion angle” indicates how much the protrusion directions of the protrusions 30 are each inclined from a direction perpendicular to the extension directions Q1 and Q2 of the branches 241a and 241b. In here, as illustrated in FIG. 4, an inclination angle α when the protrusions 30 are each inclined leftward is represented by a negative (minus) value, and, conversely, as illustrated in FIG. 5, an inclination angle β when the protrusions 30 are each inclined rightward is represented by a positive (plus) value. Respective values of “Protrusion amount/branch width”, “Presence or absence of shift between protrusions facing each other”, and “Protrusion angle” regarding “Comparative Example 2” and “Example 1” to “Example 10” of the present disclosure and their states are as illustrated in FIG. 10.

As illustrated in “Improvement rate of discharging speed” in FIG. 10, there were improvements in discharging speed in all the cases of “Example 1” to “Example 10” of the present disclosure, according to the results of the tests. In “Comparative Example 2”, on the other hand, there was no observed improvement in discharging speed. From the results, as in “Example 1” to “Example 10” of the present disclosure, it has been confirmed that setting the height T2 of each of the protrusions 30 to be an identical height to the height T1 of each of the side wall surfaces 41 makes it possible to acquire satisfactory effects of reinforcement according to the protrusions 30, making it possible to effectively achieve improvements for a lowered discharging speed along with deformation. In “Example 3” to “Example 10” in which “Protrusion amount/branch width” was equal to or greater than 20%, in particular, among Examples of the present disclosure, there have been great improvements in discharging speed. It can be said that a greater protrusion amount of each of the protrusions 30 is preferable in suppressing deformation of the liquid discharge head.

Although not reflected in the results illustrated in FIG. 10, it has been observed that there has been a slightly lowered discharging speed, in “Example 9” and “Example 10” in which “Protrusion amount/branch width” was 30%, compared with a case where “Protrusion amount/branch width” was 20%. Since, if the percentage occupied by the protrusion amount L of each of the protrusions 30 is further increased, there is a concern that discharge failure, for example, may occur, it is preferable that the percentage occupied by the protrusion amount L of each of the protrusions 30 be equal to or smaller than 30%. It can be said that it is preferable that the percentage occupied by the protrusion amount L of each of the protrusions 30 in the width W of each of the grooves 39 (“Protrusion amount/branch width”) be equal to or greater than 20% and equal to or smaller than 30% (20%≤L/W×100≤30%). In “Example 4” and “Example 5” in which “Protrusion angle” was +/−30°, it has been observed that there has been slight deterioration of fluidity around the base portion of each of the protrusions 30. Since, if the inclination angles α and β in the protrusion directions of the protrusions 30 are further increased, there is a concern about a defect due to immobility of ink, it is preferable that the inclination angles α and β in the protrusion directions of the protrusions 30 each be equal to or smaller than 30°. It can be said that it is preferable that each of the inclination angles α and β in the protrusion directions of the protrusions 30 be greater than 0° and equal to or smaller than 30° (0°<α and β≤30°).

Although some embodiments of the present disclosure has been described above, the present disclosure is not limited to the embodiments described above, and it is possible to appropriately apply modifications without departing from the gist of the disclosure.

Although, in the above-described embodiment of the present disclosure, similar to the comparative example, the pressure chambers 220 are disposed to overlap the common supply channel branches 241a and the common collection channel branches 241b without overlapping the common supply channel mainstream 240a and the common collection channel mainstream 240b when viewed in the stacking direction of the members or the discharging direction (see FIG. 19), the present disclosure is not limited to have such a configuration, and is applicable to liquid discharge heads having other configurations.

Although, in the above-described embodiment of the present disclosure, the pressure chambers 220 are disposed to extend in a direction (for example, in a direction toward upper right in FIG. 19,) different from the extension directions Q1 and Q2 in which the common supply channel branches 241a and the common collection channel branches 241b extend, the arrangement and orientation of the pressure chambers 220 are not limited to the embodiment, and it is possible to appropriately apply modifications.

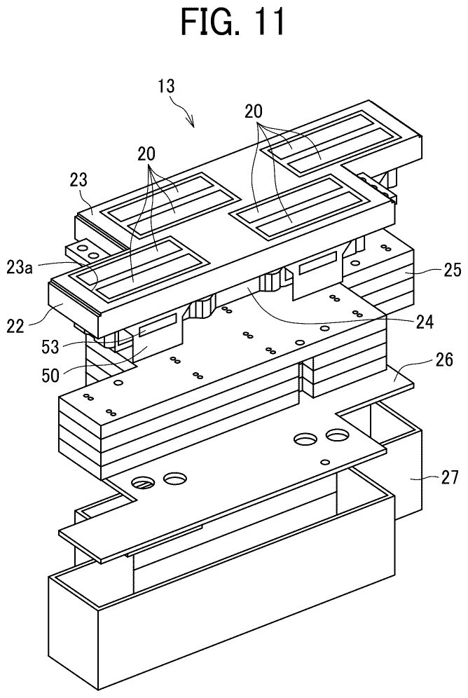

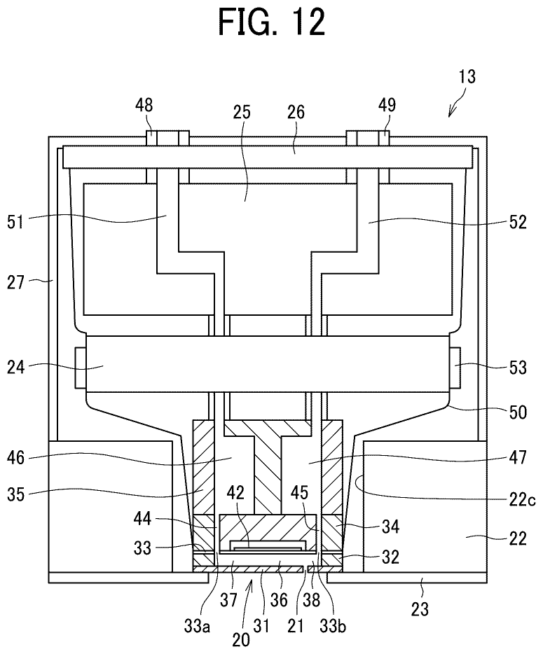

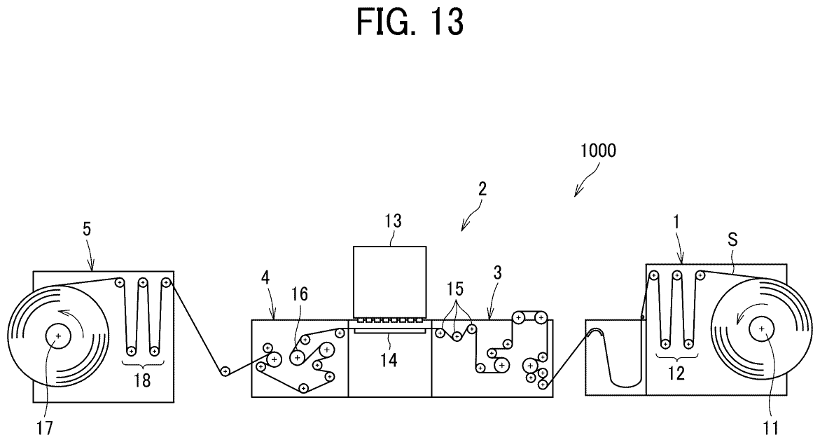

An example of a head unit 13 on which liquid discharge heads 20 are mounted are described below with reference to FIGS. 11 and 12.

FIG. 11 is an exploded perspective view of the head unit 13, illustrating an overall configuration of the head unit 13. FIG. 12 is a cross-sectional view of the head unit 13 illustrated in FIG. 11.

As illustrated in FIG. 11, the head unit 13 includes a plurality of liquid discharge heads 20, a base member 22, a cover member 23, a heat dissipation member 24, a manifold 25, a printed circuit board (PCB) 26, and a module case 27.

The plurality of liquid discharge heads 20 are held by the base member 22 serving as a holding member. To attach the liquid discharge heads 20 to the base member 22, the liquid discharge heads 20 are first inserted into openings 22c (see FIG. 12) formed in the base member 22. Next, the liquid discharge heads 20 are joined to the cover member 23 joined to the base member 22. The cover member 23 is formed with hole portions 23a (see FIG. 11) respectively corresponding to the liquid discharge heads 20, and a peripheral portion of each of the liquid discharge heads 20 is joined to an edge of each of the hole portions 23a. The liquid discharge heads 20 are secured to the base member 22 with screws and secured. Specifically, flange portions of a common channel member 35 (see FIG. 12) that each of the liquid discharge heads 20 has are disposed on a front side and a back side in longitudinal directions of each of the liquid discharge heads 20 (directions orthogonal to a paper plane of FIG. 12), and the flange portions are secured to the base member 22 with screws. Accordingly, the common channel member 35 is held by the base member 22, and each of the liquid discharge heads 20 is secured. An attachment method for the liquid discharge heads 20 and the base member 22 is not limited to securing with screws, and an attachment method such as adhesion or caulking may be used.

As illustrated in FIG. 12, for example, the liquid discharge heads 20 each include, for example, a nozzle plate 31 provided with a nozzle 21, an individual channel member 32 formed with a pressure chamber 36 communicating with the nozzle 21, a vibration plate member 33 including a piezoelectric element 42, a holding substrate 34 stacked on the vibration plate member 33, and the common channel member 35 serving as a frame member stacked on the holding substrate 34.

In addition to the pressure chamber (individual liquid chamber) 36, the individual channel member 32 is formed with an individual supply channel 37 communicating with the pressure chamber 36 and an individual collection channel 38 communicating with the pressure chamber 36. The holding substrate 34 is formed with a supply-side intermediate individual channel 44 communicating with the individual supply channel 37 via a supply-side opening portion 33a of the vibration plate member 33 and a collection-side intermediate individual channel 45 communicating with the individual collection channel 38 via a collection-side opening portion 33b of the vibration plate member 33.

The common channel member (frame member) 35 is formed with a common supply channel 46 communicating with the supply-side intermediate individual channel 44 and a common collection channel 47 communicating with the collection-side intermediate individual channel 45. The common supply channel 46 communicates with a supply port 48 via a channel 51 of the manifold 25, and the common collection channel 47 communicates with a collection port 49 via another channel 52 of the manifold 25.

The printed circuit board 26 is electrically coupled to the piezoelectric element 42 in each of the liquid discharge heads 20 via a flexible wiring member 50. A drive circuit (driver integrated circuit (IC)) 53 is mounted on the flexible wiring member 50.

When at least either the common supply channel 46 or the common collection channel 47 includes one or a plurality of common channel mainstreams and a plurality of common channel branches respectively branching from the common channel mainstream(s), and the common channel branches are formed to be inclined with respect to the common channel mainstream(s), also in each of the liquid discharge heads 20 mounted on the head unit 13 having the configuration described above, deformation may occur due to the inclination of the common channel branches. It is preferable that embodiments of the present disclosure be applied to suppress deformation. That is, providing, on side wall surfaces of grooves forming the common channel branches, protrusions each having a height identical to a height of each of the side wall surfaces makes it possible to suppress deformation of each of the liquid discharge heads 20, making it possible to secure satisfactory discharging performance.

Next, an example of a liquid discharge apparatus is described below.

FIG. 13 is a schematic view of an inkjet type image forming apparatus 1000 that is an example of a liquid discharge apparatus, illustrating the overall configuration of the inkjet type image forming apparatus 1000.

As illustrated in FIG. 13, the image forming apparatus 1000 includes a sheet supply unit 1, a sheet conveying unit 3, an image forming unit 2, a drying unit 4, and a sheet collection unit 5.

The sheet supply unit 1 is a unit that supplies sheet S on which an image is to be formed. Specifically, the sheet supply unit 1 includes a supply roller 11 onto which the sheet S that is a long sheet roll is wound and a tension adjustment mechanism 12 that adjusts tension to be applied to the sheet S. The supply roller 11 is rotatable in a direction of an arrow illustrated in FIG. 13, and the sheet S is supplied as the supply roller 11 rotates. The tension adjustment mechanism 12 includes a plurality of adjustment rollers on which the sheet S stretches to apply tension. The sheet S is adjusted in tension as intervals between the adjustment rollers are changed, allowing the sheet S to be supplied at constant tension.

The sheet conveying unit 3 is a unit that functions as a conveyer that conveys the sheet S. The sheet conveying unit 3 includes, for example, a plurality of conveying rollers 15 for conveying the sheet S. As the sheet S is supplied from the sheet supply unit 1 to the sheet conveying unit 3, the plurality of conveying rollers 15 convey the sheet S to the image forming unit 2.

The image forming unit 2 is a unit that forms an image on the sheet S. Specifically, the image forming unit 2 includes the head unit 13 that discharges liquid such as ink onto the sheet S and a platen 14 serving as a sheet support member that supports the sheet S. The sheet S, which the conveying rollers 15 have conveyed and the platen 14 supports, passes below the head unit 13. At this time, as the head unit 13 discharges the liquid (ink) onto the sheet S based on image information that has been inputted, an image is formed on the sheet S.

The drying unit 4 is a unit that allows the ink on the sheet S to be dried. The drying unit 4 includes, for example, a heating drum 16 serving as a heater that heats the sheet S. The heating drum 16 is a cylindrical heating member in which a heating source such as a halogen heater is accommodated. When the sheet S on which the image is formed in the image forming unit 2 is conveyed to the drying unit 4, the sheet S comes into contact with an outer peripheral surface of the heating drum 16, allowing the sheet S to be heated and dried. In addition to a contact type heater such as the heating drum 16, a non-contact type heater such as a hot air generator that blows hot air onto the sheet S may also be used as a heater that heats the sheet S.

The sheet collection unit 5 is a unit that collects the sheet S on which the image is formed. Specifically, the sheet collection unit 5 includes a collection roller 17 that winds and collects the sheet S and a tension adjustment mechanism 18 that adjusts the sheet S in tension. The collection roller 17 is rotatable in a direction of an arrow illustrated in FIG. 13, and the sheet S is wound into a roll shape and collected as the collection roller 17 rotates. The tension adjustment mechanism 18 includes a plurality of rollers, similar to the tension adjustment mechanism 12 of the sheet supply unit 1. The sheet S is adjusted in tension as intervals between the adjustment rollers are changed, allowing the collection roller 17 to wind and collect the sheet S at constant tension.

As the head unit 13 mounted on the inkjet type image forming apparatus 1000 as described above, there are a so-called line type head unit that discharges liquid while being stationary with respect to sheet S to be conveyed and a so-called serial type head unit that discharges liquid while moving, with respect to sheet S, in directions (sheet width directions) orthogonal to a conveyance direction of the sheet S. Embodiments of the present disclosure are applicable to both line type and serial type head units, making it possible to suppress deformation of a liquid discharge head included in each of the head units. Configurations of the head units of the respective types will now be briefly described herein.

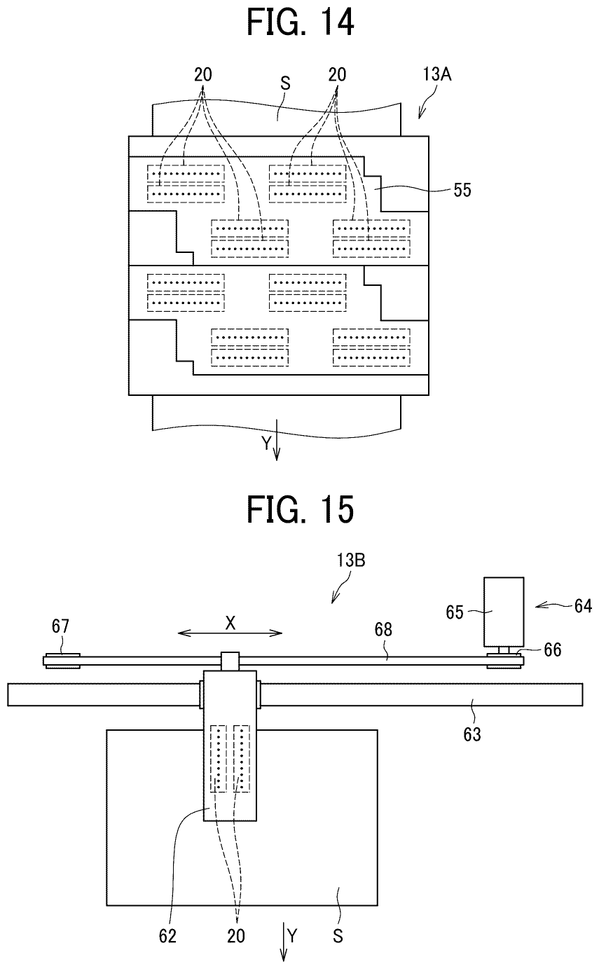

FIG. 14 is a plan view illustrating a configuration of a line type head unit 13A.

The line type head unit 13A illustrated in FIG. 14 includes a head holding member 55 that holds the plurality of liquid discharge heads 20. The plurality of liquid discharge heads 20 are disposed in a staggered manner as illustrated in FIG. 14, for example. As sheet S is conveyed in a direction Y that an arrow indicates in FIG. 14 and reaches a position facing the head unit 13A, the liquid discharge heads 20 discharge the liquid. At this time, the liquid discharge heads 20 discharge the liquid while the head unit 13A is stationary with respect to the sheet S being conveyed, forming an image on the sheet S.

Next, a configuration of a serial type head unit will now be described herein.

FIG. 15 is a plan view of a configuration of a serial type head unit 13B.

The serial type head unit 13B illustrated in FIG. 15 includes a carriage 62 mounted with the plurality of liquid discharge heads 20, a guide member (guide rod) 63 for guiding the carriage 62 in main scanning directions X that are the sheet width directions (directions orthogonal to the conveying direction Y), and a drive device 64 that causes the carriage 62 to move.

The drive device 64 includes, for example, a motor 65 serving as a drive source and a timing belt 68 that is wound around a drive pulley 66 and a driven pulley 67. As the motor 65 is driven and the drive pulley 66 is rotated, the timing belt 68 performs circulation movement, allowing the carriage 62 to move in one of the main scanning directions X along the guide member 63. As the motor 65 is switched in its rotation direction between one direction and its opposite direction, the carriage 62 moves in a reciprocated manner in the main scanning directions X.

As sheet S is conveyed in the direction Y that the arrow indicates and the sheet S reaches a predetermined image forming position, as illustrated in FIG. 15, the sheet S is temporarily stopped in movement. While the carriage 62 moves in the main scanning directions X, the liquid discharge heads 20 discharge liquid (ink). A part of an image, which corresponds to one row, is formed on the sheet S being stationary. After that, the sheet S is intermittently moved in the direction Y that the arrow indicates, the carriage 62 repeatedly moves in a reciprocated manner, and discharging operations of the liquid discharge heads 20 are repeatedly performed, sequentially forming parts of the image on the sheet S.

The liquid discharge head and the head unit according to the present disclosure are applicable to not only the image forming apparatus that is an example of a liquid discharge apparatus, but also other liquid discharge apparatuses.

For example, the liquid discharge head and the head unit according to the present disclosure are also applicable to an electrode manufacturing apparatus that discharges a liquid composition to manufacture an electrode. An example of an electrode manufacturing apparatus will be described below.

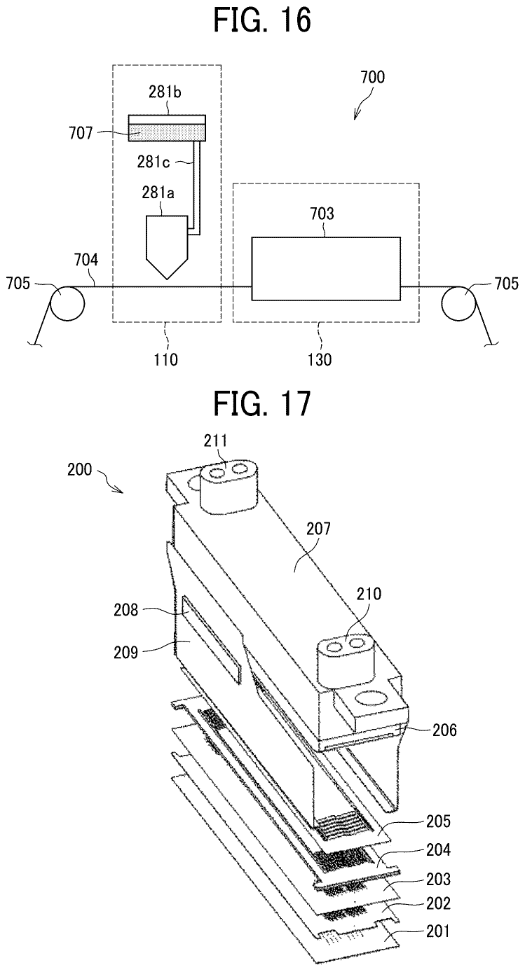

FIG. 16 is a schematic view of an electrode manufacturing apparatus 700, illustrating an overall configuration of the electrode manufacturing apparatus 700.

In here, as an example of the electrode manufacturing apparatus 700, a manufacturing apparatus for forming an electrode mixture layer containing an active material on an electrode substrate (current collector) will now be described herein. The electrode mixture layer is used, for example, as a component of an electrochemical element. There is no limitation in particular in other components in the electrochemical element than the electrode mixture layer, and it is possible to appropriately select a known one. For example, a positive electrode, a negative electrode, and a separator are other components than the electrode mixture layer.

The electrode manufacturing apparatus 700 illustrated in FIG. 16 includes a discharging process section 110 that performs a process of applying a liquid composition for manufacturing an electrode onto a printing base material 704 including a discharge target to form a liquid composition layer and a heating process section 130 that performs a heating process of heating the liquid composition layer to acquire an electrode mixture layer.

The electrode manufacturing apparatus 700 includes a conveyor 705 that conveys the printing base material 704. The conveyor 705 conveys the printing base material 704 to the discharging process section 110 and the heating process section 130 in this order at a speed that is set beforehand. There is no limitation in particular in manufacturing method for the printing base material 704 including the discharge target such as an active material layer, and it is possible to appropriately select a known method. The discharging process section 110 includes a liquid discharge head 281a that achieves an application process of applying the liquid composition onto the printing base material 704, a storage container 281b that stores a liquid composition 707, and a supply tube 281c for supplying the liquid composition 707 stored in the storage container 281b to the liquid discharge head 281a.

In the discharging process section 110, the liquid discharge head 281a discharges the liquid composition 707 to apply the liquid composition 707 onto the printing base material 704 to form a thin-film-shaped liquid composition layer. The storage container 281b may be a component integrated with an electrode manufacturing apparatus or may be a component detachable from an electrode manufacturing apparatus. The storage container 281b may be a storage container integrated with an electrode manufacturing apparatus or a container used for performing addition to a storage container detachable from an electrode manufacturing apparatus.

The storage container 281b and the supply tube 281c are desirably selectable as long as it is possible to stably store and supply the liquid composition 707.

The heating process section 130 performs a solvent removal process of heating and removing a solvent remaining in the liquid composition layer. Specifically, a heating device 703 of the heating process section 130 heats and causes to dry the solvent remaining in the liquid composition layer, removing the solvent from the liquid composition layer. The electrode mixture layer is formed. The solvent removal process performed in the heating process section 130 may be performed under an environment where pressure is reduced.

The heating device 703 is not limited in particular, and it is possible to appropriately select one in accordance with a purpose. For example, the heating device 703 may be a substrate heater, an infrared (IR) heater, or a hot air heater. The heating device 703 may be a combination of at least two of the substrate heater, the IR heater, and the hot air heater. It is possible to appropriately select a heating temperature and a period of time of heating in accordance with a boiling point of a solvent contained in the liquid composition 707 or a thickness of a film to be formed.

There is no limitation in particular in target to which a liquid composition is to be discharged (hereinafter also referred to as a “discharge target”), as long as it is a target on which a layer containing an electrode material is to be formed, and it is possible to appropriately select one in accordance with a purpose. For example, the target may be an electrode substrate (current collector), an active material layer, or a layer containing a solid electrode material. The target may be an electrode mixture layer containing an active material on an electrode substrate (current collector). A discharger and a discharging process may respectively be a device and a process of directly discharging a liquid composition to form a layer containing an electrode material, as long as it is possible to form a layer containing an electrode material on a discharge target. The discharger and the discharging process may be a device and a process of indirectly discharging a liquid composition to form a layer containing an electrode material.

Since the electrode manufacturing apparatus 700 described above can suppress deformation of the liquid discharge head and secure satisfactory discharging performance, it is possible to achieve discharging of a liquid composition to an intended position on the discharge target.

The liquid discharge apparatus according to the present disclosure may be an apparatus that discharges liquid onto one to which the liquid adheres and is fixed, as long as it is possible to at least temporarily allow the liquid to adhere. The liquid discharge apparatus according to the present disclosure may be an apparatus that discharges liquid onto one to which the liquid adheres and permeates. For example, a target onto which liquid is discharged may be a resin film, a wallpaper, or an electronic substrate, instead of paper. For example, a material of a target onto which liquid is discharged may be paper, leather, metal, plastic, glass, wood, or ceramics.

There is no limitation in particular in liquid that the liquid discharge apparatus according to the present disclosure discharges, and examples of the liquid include solutions, suspensions, and emulsions containing water, solvents such as organic solvents, colorants such as dyes and pigments, function-imparting materials such as polymerizable compounds, resins, and surfactants, biocompatible materials such as deoxyribonucleic acid (DNA), amino acids, proteins, and calcium, edible materials such as natural pigments, and the like. These materials are used for, for example, inkjet ink, surface treatment liquid, electronic element, constituent element of light emitting element, liquid for forming electronic circuit resist pattern, material liquid for three-dimensional modeling, and the like.

To summarize the aspects of the present disclosure described above, the present disclosure includes at least the following aspects.

### Aspect 1

A liquid discharge head includes: a plurality of nozzles to discharge liquid; a plurality of pressure chambers communicating with the plurality of nozzles; a plurality of individual channels communicating with the plurality of pressure chambers; a plurality of common channel branches disposed to overlap the plurality of pressure chambers when viewed in a discharging direction of the liquid discharged from the nozzles, the plurality of common channel branches communicating with the plurality of individual channels; and a common channel mainstream communicating with the plurality of common channel branches. Each of the plurality of common channel branches is disposed to be inclined at an angle in a range greater than 45° and smaller than 90° with respect to the common channel mainstream. A protrusion having the same height as a height of a side wall surface of a groove forming one of the plurality of common channel branches is disposed to protrude from the side wall surface.

### Aspect 2

The liquid discharge head according to Aspect 1 includes a plurality of protrusions, including the protrusion, disposed at equal intervals on the side wall surface.

### Aspect 3

In the liquid discharge head according to Aspect 1 or 2, the protrusion protrudes in a direction orthogonal to the one of the plurality of common channel branches.

### Aspect 4

In the liquid discharge head according to Aspect 1 or 2, the protrusion protrudes in a direction within a range equal to or smaller than 30° from a direction orthogonal to the one of the plurality of common channel branches.

### Aspect 5

In the liquid discharge head according to any one of Aspects 1 to 4, a percentage occupied by a protrusion amount of the protrusion in a width of the groove is equal to or larger than 20% and equal to or smaller than 30%.

### Aspect 6

In the liquid discharge head according to any one of Aspects 1 to 5, a tip of the protrusion has a convex curved surface.

### Aspect 7

In the liquid discharge head according to any one of Aspects 1 to 6, the protrusion includes the same material as a material of a structural component including the plurality of common channel branches.

### Aspect 8

In the liquid discharge head according to any one of Aspects 1 to 7, when the plurality of pressure chambers, the common channel mainstream, and the plurality of common channel branches are viewed in the discharging direction, the plurality of pressure chambers are disposed to overlap the plurality of common channel branches without overlapping the common channel mainstream.

### Aspect 9

In the liquid discharge head according to any one of Aspects 1 to 8, each of the plurality of individual channels includes an individual supply channel and an individual collection channel, the plurality of common channel branches include a common supply channel branch communicating with the individual supply channel and a common collection channel branch communicating with the individual collection channel, and the side wall surface of the groove forming the one of the plurality of common channel branches is a side wall surface of a partition wall between the common supply channel branch and the common collection channel branch.

### Aspect 10

In the liquid discharge head according to any one of Aspects 1 to 9, the plurality of pressure chambers are disposed to extend in a direction different from a direction in which the plurality of common channel branches extend.

### Aspect 11

A head unit includes a plurality of liquid discharge heads including the liquid discharge head according to any one of Aspects 1 to 10.

### Aspect 12

A liquid discharge apparatus includes the liquid discharge head according to any one of Aspects 1 to 10 or the head unit according to Aspect 11.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge head, comprising:
a plurality of nozzles to discharge liquid;
a plurality of pressure chambers communicating with the plurality of nozzles;
a plurality of individual channels communicating with the plurality of pressure chambers;
a plurality of common channel branches disposed to overlap the plurality of pressure chambers when viewed in a discharging direction of the liquid discharged from the plurality of nozzles, the plurality of common channel branches communicating with the plurality of individual channels; and
a common channel mainstream communicating with the plurality of common channel branches,
wherein each of the plurality of common channel branches is inclined at an angle in a range greater than 45° and smaller than 90° with respect to the common channel mainstream, and
a protrusion having a same height as a height of a side wall surface of a groove forming one of the plurality of common channel branches protrudes from the side wall surface.

2. The liquid discharge head according to claim 1, further comprising a plurality of protrusions, including the protrusion, disposed at equal intervals on the side wall surface.

3. The liquid discharge head according to claim 1,
wherein the protrusion protrudes in a direction orthogonal to the one of the plurality of common channel branches.

4. The liquid discharge head according to claim 1,
wherein the protrusion protrudes in a direction within a range equal to or smaller than 30° from a direction orthogonal to the one of the plurality of common channel branches.

5. The liquid discharge head according to claim 1,
wherein a percentage occupied by a protrusion amount of the protrusion in a width of the groove is equal to or greater than 20% and equal to or smaller than 30%.

6. The liquid discharge head according to claim 1,
wherein a tip of the protrusion has a convex curved surface.

7. The liquid discharge head according to claim 1,
wherein the protrusion includes a same material as a material of a structural component comprising the plurality of common channel branches.

8. The liquid discharge head according to claim 1,
wherein, when the plurality of pressure chambers, the common channel mainstream, and the plurality of common channel branches are viewed in the discharging direction, the plurality of pressure chambers are disposed to overlap the plurality of common channel branches without overlapping the common channel mainstream.

9. The liquid discharge head according to claim 1,
wherein each of the plurality of individual channels includes an individual supply channel and an individual collection channel,
the plurality of common channel branches include a common supply channel branch communicating with the individual supply channel and a common collection channel branch communicating with the individual collection channel, and
the side wall surface of the groove forming the one of the plurality of common channel branches is a side wall surface of a partition wall between the common supply channel branch and the common collection channel branch.

10. The liquid discharge head according to claim 1,
wherein the plurality of pressure chambers extend in a direction different from a direction in which the plurality of common channel branches extend.

11. A head unit, comprising a plurality of liquid discharge heads including the liquid discharge head according to claim 1.

12. A liquid discharge apparatus, comprising the liquid discharge head according to claim 1.
